(19) United States
(12) Patent Application Publication
(10) Pub. No.: US 2025/0297741 A1
(43) Pub. Date: Sep. 25, 2025

(54) Barbeque Grill

(71) Applicant: Colt McCune, Hays, KS (US)

(72) Inventor: Colt McCune, Hays, KS (US)

(21) Appl. No.: 19/233,918

(22) Filed: Jun. 10, 2025

(51) Int. Cl. F24C 1/16; A47J 37/07; F24C 15/08

(52) U.S. Cl. CPC F24C 1/16; A47J 37/0713; A47J 37/0786; F24C 15/086

(57) ABSTRACT

A barbeque grill incorporating a baking case and grill assembly; the barbeque grill further incorporating a cabinet supporting the baking case and grill assembly, the cabinet having a plurality of vertical walls; the barbeque grill further incorporating a plurality of quill and stem assemblies, each of which is fixedly mounted within the cabinet; the barbeque grill further incorporating a plurality of feet, each foot being fixedly attached to a lower end of one of the stem components; the barbeque grill further incorporating a plurality of screw actuators, each of which is connected operatively to one of the quill and stem assemblies for upwardly and downwardly moving a stem component; the barbeque grill further incorporating turnable shafts which are connected operatively to the screw actuators, each turnable shaft having a head end which is accessible at an exterior side of one of the vertical walls.

### FIELD OF THE INVENTION

The instant invention relates to barbeque grills. More particularly, the instant invention relates to mechanical adaptations of barbeque grills which allow the barbeque grill to maintain level cooking and serving surfaces while the barbeque grill rests upon a sloped or an uneven ground or floor surface.

### BACKGROUND OF THE INVENTION

Barbeque grills are often stored in a garage of a residence, and in many cases a desirable location for cooking use of a barbeque grill is immediately outside of the garage's entryway. In many circumstances, the driveway serving the home's garage slopes upwardly from street level to the garage's entry. In such circumstances, the barbeque grill may itself be undesirably sloped or tilted, interfering with proper usage of the grill's cooking and serving surfaces. Proper usage of a barbeque grill commonly requires that the grill's cooking and serving surfaces be level, extending substantially horizontally.

The instant inventive barbeque grill solves or ameliorates the above-described barbeque grill usage problems and challenges by providing specially adapted feet which allow a user of the barbeque grill to easily and conveniently selectively extend and retract the grill's feet, advantageously leveling the barbeque grill for proper usage upon sloped or uneven surfaces.

### BRIEF SUMMARY OF THE INVENTION

The instant inventive barbeque grill incorporates an upper baking case. In a commonly configured rendition of the instant invention, the upper baking case component comprises a grill with underlying gas burners, and incorporating an overlying pivoting or removable lid. Alternatively, the space within the baking case which underlies the grill may be adapted for supporting a body of charcoal brickettes. In a common configuration, lateral or left and right sides or ends of the baking case present cantilevering counter surfaces which may include a stove-top gas burner. During use and operation of such counter surfaces, and during use of the baking case's grill, the grill and counter surfaces are preferably maintained in a substantially horizontal and level orientation.

A further structural component of the instant inventive barbeque grill comprises a cabinet which underlies and supports the upper baking case component. In a preferred embodiment, the cabinet comprises a plurality of vertical walls, preferably including a left wall, a right wall, and a rear wall. A front wall of the cabinet may be configured for service as pivoting access doors. In a preferred embodiment, the cabinet may incorporate a lower wall or floor which may be utilized for support and storage of items such as a propane gas canister, charcoal briquettes, wood pellets, and cooking utensils.

A further structural component of the instant inventive barbeque grill comprises a plurality of quill and stem assemblies which function as adjustable cabinet support components. The stem components of such assemblies are preferably slidably and telescopingly mounted within such assembly's quill components. In a preferred embodiment, such assemblies are fixedly mounted within the cabinet, each quill and stem combination being mounted in a vertical orientation at one of the interior corners of the cabinet.

A further structural component of the instant inventive barbeque grill comprises a plurality of feet, each foot preferably being fixedly attached to a lower end of one of the telescoping stem components. In a preferred embodiment, each foot component is configured as a roller or wheel.

Further structural components of the instant inventive barbeque grill comprise a plurality of screw actuators. In a preferred embodiment, each screw actuator comprises an externally helically threaded shaft in combination with an internally helically threaded sleeve. In a suitable embodiment, the screw actuators' helically threaded sleeve components are fixedly attached to the quill and stem assemblies' stem components, while the screw actuators' helically threaded shaft components have their motions mechanically restricted to rotations about their vertical axes. Rotary motions of the helically threaded shafts about their vertical axes operatively draw and drive the helically threaded sleeves and their attached stem components upwardly and downwardly, telescopingly extending and retracting the wheel configured lower ends of the stems beneath the cabinet's floor.

In an alternative configuration, motions of internally helically threaded sleeves are mechanically restricted to rotations about their vertical axes. Upon rotations of such alternatively supported sleeve components, the non-rotating externally helically threaded shaft components are drawn upwardly or driven downwardly by the rotating sleeve components. Such threaded shafts are preferably fixedly and rigidly attached to the stem components, resulting in corresponding telescoping retractions and extensions of the wheel configured lower ends of the stems.

Further structural components of the instant inventive barbeque grill comprise turning means which are operatively connected to the screw actuators for turning their rotatably mounted components. In a preferred embodiment, each turning means is adapted to be accessed by an operator at an exterior side or sides of the cabinet's vertical walls. In a preferred embodiment, each turning means is further adapted for translating rotary force or torque about a horizontal axis to rotary force or torque about vertical axis. In such embodiment, the vertical axes are mechanically associated with the above-described rotating externally helically threaded shaft or the above-described rotating internally helically threaded sleeve.

In a preferred embodiment, a rotary power input ends of the turning means may comprise rotatable and horizontally extending drive shafts which have turnable heads exposed at the cabinet's exterior walls. In such embodiment, the turning means' turnable heads suitably comprise cylindrical or hexagonal Allen wrench sockets which are exposed within circular apertures which open the cabinet at its left and right vertical walls. The turning means further comprise bevel gear trains or worm gear trains which are mechanically linked to the drive shafts, and which engage upper ends of the screw actuators.

In operation of the instant inventive barbeque grill, and assuming the provision of the above-described preferred components, the barbeque grill may be initially stored in the garage of a home having a sloped driveway leading to the garage's entry. A homeowner intending to operate the inventive barbeque grill for outdoor cooking may initially roll the barbeque grill out of the garage and onto the sloped driveway surface, immediately outside of the garage's entry. Thereafter, such operator may engage caster wheel locks to prevent the barbeque grill from rolling down slope. Thereafter, the operator may selectively engage an Allen wrench with the Allen socket configured drive shaft heads which are exposed upon the downslope wall of the barbeque grill's cabinet. Upon such wrench engagements, the Allen wrench may be turned to downwardly extend the barbeque grills' downslope telescoping stems and wheels, thereby leveling the barbeque grill.

Accordingly, objects of the instant invention include the provision of a barbeque grill which incorporates structures as described above, and which arranges those structures in relation to each other in manners described above for the performance and achievement of beneficial functions as described above.

Other and further objects, benefits, and advantages of the instant invention will become known to those skilled in the art upon review of the detailed descriptions which follow, and upon review of the appended drawings.

### BRIEF DESCRIPTION OF DRAWINGS

FIG. 1 is a perspective view of the instant inventive barbeque grill.

FIG. 2 is a reverse perspective view of the instant inventive barbeque grill, the view showing roller feet and stem components alternatively configured, the view having a lid cut away section exposing interior structures.

FIG. 3 is a partial sectional view as indicated in FIG. 1.

FIG. 4 is an alternative partial sectional view as indicated in FIG. 3.

FIG. 5 re-depicts the structure of FIG. 3, the view of FIG. 5 showing screw actuator assembly components alternatively configured.

FIG. 6 re-depicts a portion of the structure of FIG. 3, the view of FIG. 6 showing an alternative screw actuator driving gear train.

### DETAILED DESCRIPTION OF THE INVENTION

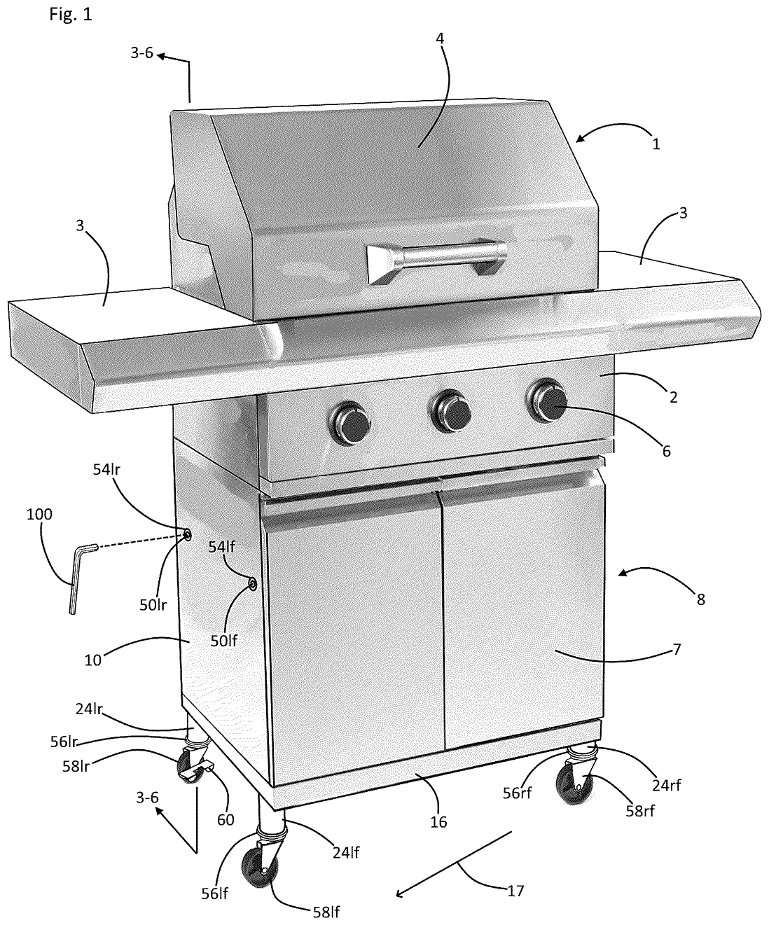

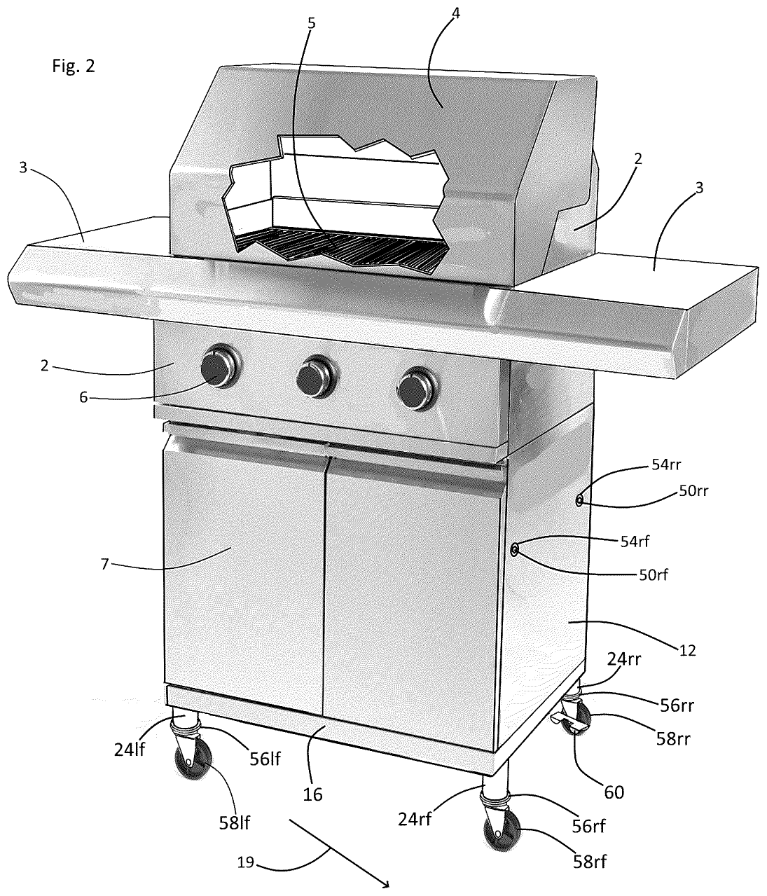

Referring now to the drawings, and in particular to FIGS. 1 and 2, the instant inventive barbeque grill preferably comprises an upper baking case which is referred to generally by reference arrow 1. The baking case 1 has a body 2, and has an upper pivoting or removable lid 4. Ledge or counter surfaces 3 which cantilever leftwardly and rightwardly from the baking case's body 2 are suitably provided. Upon opening the lid 4, an interior food item cooking grill 5 is exposed. In a commonly configured embodiment, propane gas burners (not depicted within views) underlie the grill 5, the flame level of such burners being adjustable by means of turning burner volume adjustment knobs 6.

A further structural component of the instant inventive barbeque grill comprises a cabinet which is referred to generally by reference arrow 8. Referring simultaneously to FIGS. 1-4, the cabinet suitably comprises a left vertical wall 10, a right vertical wall 12, a rear vertical wall 15, and a lower horizontally extending floor 16. In the depicted suitable embodiment, the front wall of the cabinet 8 may comprise left and right cabinet doors 7. The cabinet conventionally functions as a stand or pedestal for supporting the overlying baking case and grill assembly, the cabinet also providing storage for items such as a propane tank, outdoor cooking utensils, charcoal brickettes, wood pellets, and charcoal lighter fluid (not depicted within views).

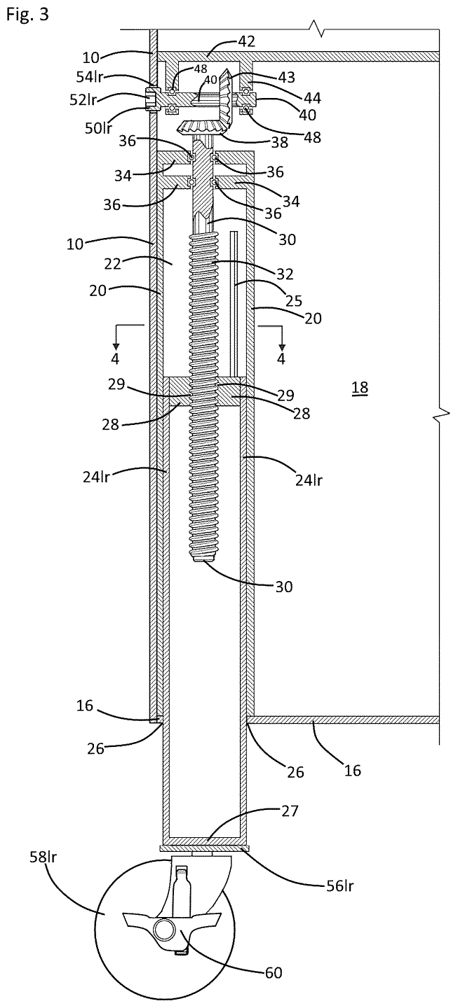

Referring simultaneously to FIGS. 1-3, the instant inventive barbeque grill preferably further comprises a plurality of slidably interconnected and telescoping quill and stem assemblies. The embodiment of FIG. 3 includes an exemplary depiction of components installed at the left rear (i.e. “Ir”) interior corner of the cabinet 8.

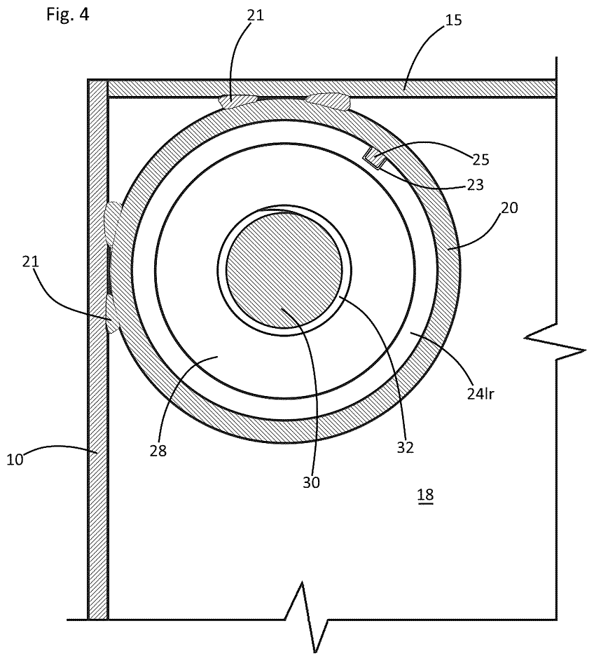

Each of the assembly's quill components suitably comprises a steel cylindrical tube 20 which slidably receives a steel cylindrical stem component, 24lr, 24ef, 24rr, or 24rf. The outside diameters of such stem components are preferably closely fitted for nesting receipts within the inside diameters of the cylindrical sleeves 20, such nesting receipts allowing the stem components to slidably move upwardly and downwardly within the interior hollow bores 22 of the quill components. To prevent the lower ends 27 of the stem components from slidably retracting upwardly beyond the level of the cabinet's floor 16, enlarged feet 56lr, 56lf, 56rr, 56rf may be fixedly attached to the lower ends of the stem components. Referring to FIGS. 3 and 4, vertically extending key 25 and slide slot 23 combinations may be associated with the quill and stem combinations, such key and slot combination resisting rotations of the stems within the quills while permitting vertical reciprocating motions.

Referring to FIGS. 1-4, a plurality of screw actuators is preferably provided, each actuator being adapted for alternatively raising and lowering the lower end of one of the stems (24lr, 24lf, 24rr, or 24rf) with respect to the cabinet's floor 16. In a suitable embodiment, each screw actuator comprises a sleeve 28 having internal helical threads 29 in combination with a vertically extending shaft 30 having external helically extending threads 32. The threaded sleeves 28 are fixedly, immovably, and rigidily attached to the upper ends of the stems, while the motions of the vertical shafts 30 are mechanically restricted to rotations about their vertical axes. As shown in FIG. 4, the cylindrical quill components 20 may be fixedly and rigidly attached to a wall or walls 10, 12, and/or 15 of the cabinet by means of heat fusion welds 21. Support rings 34 fixedly mounted at the upper ends of the quills 20 may incorporate rotary bearings 36 which facilitate rotations of the vertical shafts 30 about their vertical axes while resisting any upward or downward motions of such shafts. Rotations and counter-rotations of the shafts 30 allow their screw threads 32 to raise and lower the sleeves 28 via their engagements with the sleeves' screw threads 29, such motions correspondingly raising and lowering the stem components 24lr, 24lf, 24rr, and rf. In a preferred embodiment, the lower ends of the stems extend downwardly from the cabinet's floor 16, such stem extensions passing through floor openings 26. Accordingly, the rotations and counter-rotations of the shafts 30 and their external helical threads 32 effectively upwardly and downwardly move the lower ends 27 of the stem attached feet 56lr, 56lf, 56rr and 56rf, toward and away from the cabinet's floor 16.

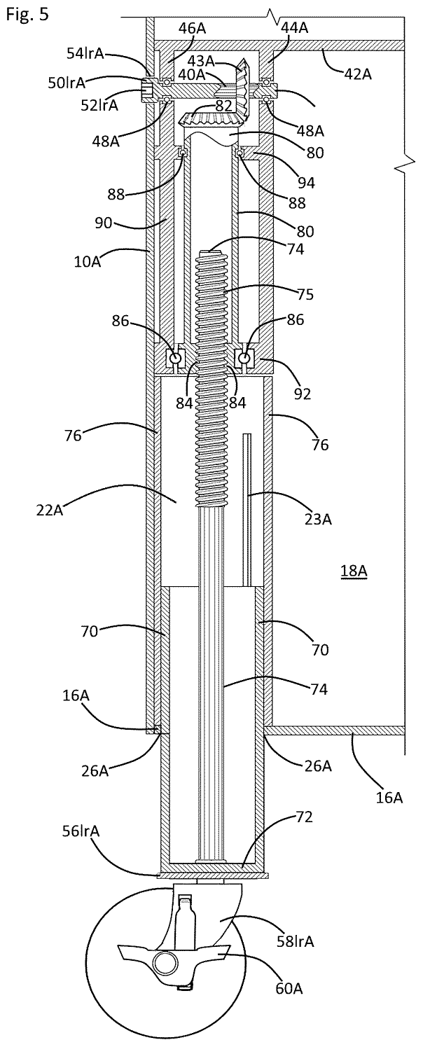

Referring simultaneously to FIGS. 3 and 5, each structure appearing in of FIG. 5 which is identified by a reference numeral having a suffix “A” is configured similarly with similarly numbered structures appearing in FIG. 3. Similarly with the exemplary screw actuator of FIG. 3, the exemplary screw actuator of FIG. 5 includes a threadedly engaged combination of an externally helically threaded shaft 74,75 with internally helically threaded sleeve 80,84. However, in the FIG. 5 screw actuator alternative, the motions of the internally helically threaded sleeves 80,84 are limited to rotations about their vertical axes. Rigidly mounted frame members 90, 92, and 94 are suitably provided for supporting lower and upper rotary bearings 86 and 88, such bearings facilitating rotations of the sleeves 80 and their radially inwardly extending helical threads 84 about their common vertical axes, while resisting any upward or downward motion of such components.

In the FIG. 5 screw actuator alternative, lower ends of shafts 74 are fixedly, rigidly, and relatively immovably attached to floor or lower end components 72 of the actuators' sliding stem components 70. Rotations and counter-rotations of the sleeves 80 and their helical threads 84 operatively drive and draw threads 75 of the shafts 74 to alternatively upwardly and downwardly move the shafts 74, such motions simultaneously upwardly and downwardly drawing and driving the stems 70 within the hollow bores 22A of the quills 76.

Referring simultaneously to FIGS. 1 and 3, the instant inventive barbeque grill preferably further comprises turning means which are connected operatively to the barbeque grill's screw actuators. The invention's turning means component may suitably comprise an Allen wrench 100 which is fitted for selective horizontal extensions into engagements with hexagonal sockets (54lr, 54fl, 54rr, or 54rf) of enlarged heads (50lr, 50lf, 50rr, or 50rf) of horizontally extending drive shafts 40. Each of such enlarged heads (head 50lr, for example) preferably extends horizontally into and resides within an aperture (aperture 54lr for example) within one of the side walls of the cabinet 8. In the FIG. 3 embodiment, the depicted rotary shaft 40 is supported at the interior 18 of the cabinet 8 for rotation about the shaft's preferably horizontal rotation axis, while movement of such shaft 40 in any other direction is mechanically restricted. Frame members 44 and 46 may suitably be rigidly mounted to an upper and interior cabinet frame member or ceiling component 42, such frame members suitably supporting rotary bearings 48 which facilitate the rotary of drive shaft 40, while resisting all other motions of such shaft.

The invention's turning means may suitably further comprise first bevel gears 43 which are fixedly and rigidly attached to drive shafts 40, such first bevel gears being paired with and engaging second bevel gears 38, each second bevel gear being fixedly attached to an upper end of one of the rotating shafts 30. Selective Allen wrench actuated turning of the horizontal drive shafts 40 may simultaneously turn the bevel gears 43 and may counterturn their paired the second bevel gears 48, simultaneously rotating the vertical shafts 30 and their helical threads 32 about their common vertical axes. Such Allen wrench actuated turning of the drive shafts' enlarged heads 50lr, 50lf, 50rr, and/or 50rf may effectively, easily, and conveniently raise and lower selected stem components 24lr, 24lr, 24rr, or 24rf along with lower wheels mounted at the stems' lower ends.

Referring further to FIG. 5, engagement of the Allen wrench 100 with shaft head 54lrA may similarly rotate bevel gear 43A, resulting in counter-rotation bevel gear 82 whose angled teeth engage the teeth of bevel gear 43A. Accordingly, selective turning and counter turning of the wall exposed head 54lrA of drive shaft 44A similarly raises and lowers stem 70 within quill 76. Renditions of the FIG. 5 assembly may be installed at and actuated at each of the four interior corners of the cabinet 8.

The enlarged drive shaft heads 50 and 50A (including lr, lf, rr, and rf renditions) shown in FIGS. 3 and 5 are considered as being representative of other commonly known shaft turning elements such as hexagonally configured shaft heads, turn handles, turn cranks, knurled knobs, and the like.

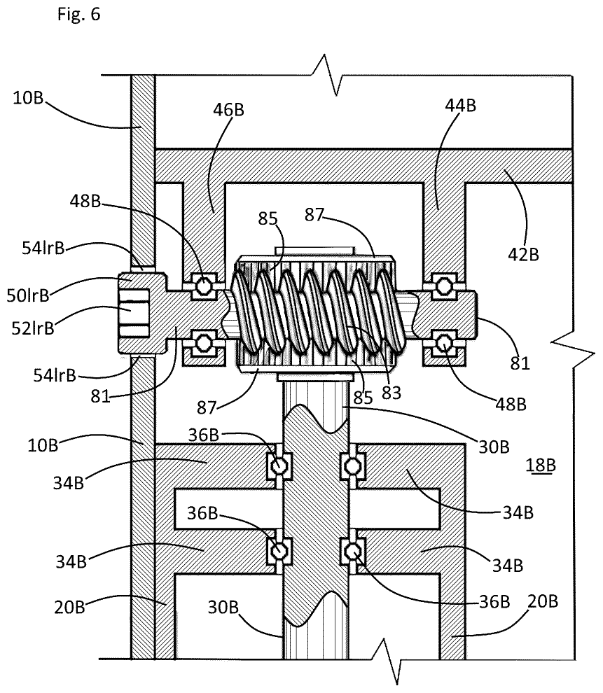

Referring simultaneously to FIGS. 3, 5, and 6, each structure appearing in FIG. 6 which is identified by a reference numeral having a suffix “B” is configured similarly with similarly numbered structures appearing in FIGS. 3 and 5. In the FIG. 6 structural alternative, the turning means comprise horizontal and rotatable drive shafts 81 which presents at their outer peripheries helical worm gears 83. Such gears engage annular arrays of vertically extending ridges and valleys 85 of adjacent toothed gears 87 which are fixedly attached to the upper ends of vertical shafts 30B. Selective Allen wrench actuated turning and counter turning of the drive shafts 81 may turn the worm gears 83, simultaneously turning and counterturning the toothed gears 87 and their attached vertical shafts 30B.

In the embodiment of FIGS. 1 and 2, apertures 54lr, 54lf, 54rr, and 54rf are presented at the cabinet's side walls 10 and 12, such apertures providing access to turning means components such as the bevel gear trains or worm gear trains described above. Such apertures also provide access points for user effected actuations of four renditions of the barbeque grill's screw actuators. Enlarged drive shaft heads which preferably present Allen wrench engaging sockets (e.g. sockets, 50lr, 50lf, 50rr, and 50rf) are preferably exposed within such side wall apertures, such enlarged shaft heads facilitating selective Allen wrench actuated raising and lowering of the stem components 24lr, 24lf, 24rr, and 24rf of the barbeque grill's quill and stem assemblies.

The barbecue grill's lower foot components 56lr, 56lr, 56rr, and 56rf are fixedly attached to the lower ends of the four stem components, such feet preferably incorporating caster adapted rollers or wheels 58lr, 58lf, 58rr, and 58rf. The rear caster wheels 58lr, and 58rr are preferably equipped with releasable locks 60 which, upon actuation, may prevent down-slope rolling of the barbeque grill.

The invention's cabinet 8 advantageously functions in multiple ways in relation to the screw actuated telescoping quill and stem combinations. The cabinet's walls 10, 12, and 15 are available for mounting and mechanical support of such combinations. The cabinet 8 also provides a storage space 18 for housing such combinations. The cabinet's walls also protectively shroud the quill and stem combinations and their screw actuator assemblies from incursions of moisture and debris. The cabinet 8 also performs a visual appearance enhancing function, allowing the barbecue grill to substantially appear to be a conventional cabinet mounted barbeque grill.

In use of the instant inventive barbeque grill, an operator may situate the grill upon a sloped surface such as garage driveway having a downward slope as represented by arrow 17 drawn on FIG. 1. To level the barbeque grill's counter surfaces 3 and cooking grill 5, the operator may engage an Allen wrench 100 with down-slope drive shaft heads 50lr and 50lf. Thereafter, the operator may selectively rotate such wrench and drive shaft heads clockwise, causing the grill's down-slope threaded shafts 30,32 to extend stems 24lr and 24lf and their attached wheels 58lr and 58lf downwardly. Such downward extensions of wheels may effectively level the grill.

Alternatively, referring to FIG. 2, barbeque grill may be turned by the operator so that the right wall 12 of the grill resides at the grill's down-slope end, as indicated by slope arrow 19. In such circumstances, similar Allen wrench engagements and rotations of the laterally exposed drive shaft heads 50rr and 50rf may extend wheels 58rr and 58rf downwardly, similarly leveling the barbeque grill.

An embodiment of the instant inventive barbeque grill which provides a quill and stem assembly at each of the interior corners of the cabinet 8 is preferred because such configuration is able to accommodate multiply sloped or irregular ground surfaces.

Notwithstanding, to achieve mechanical simplicity and materials economy, as few as two or a pair of quill and stem assemblies may be installed at opposing interior corners at the left end or at the right end of the cabinet. In use of a barbeque grill which so limits its installed quill and stem asseblies, the barbeque grill may be oriented so that the end of the grill which includes the paired quill and stem assemblies may be positioned down slope. Thereafter, the operator may selectively manipulate the down-slope pair of quill and stem assemblies to raise the down-slope end of the barbeque grill to a horizontal orientation.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A barbeque grill comprising:
a. A baking case and grill assembly;
b. A cabinet supporting the baking case and grill assembly, the cabinet comprising a plurality of vertical walls;
c. A plurality of quill and stem assemblies, each quill and stem assembly being fixedly mounted within the cabinet;
d. A plurality of feet, each foot being fixedly attached to a lower end of one of the stems;
e. A plurality of screw actuators, each screw actuator being connected operatively to one of the quill and stem assemblies for alternatively upwardly and downwardly moving said assembly's stem; and
f. Turning means connected operatively to the screw actuators, each turning means being accessible at an exterior side of one of the vertical walls.

2. The barbeque grill of claim 1, wherein the cabinet has a floor, and wherein lower ends of the quill and stem assemblys' stems are positioned for alternative movements downwardly away from the floor and upwardly toward the floor.

3. The barbeque grill of claim 2, wherein the turning means comprise a plurality of rotary shaft and shaft head combinations.

4. The barbeque grill of claim 3, further comprising a plurality of apertures, wherein each aperture opens the cabinet at one of the vertical walls, and wherein each shaft head is positioned at one of the apertures.

5. The barbeque grill of claim 1, wherein each screw actuator comprises an externally helically threaded shaft and an internally helically threaded sleeve, wherein the helical threads of such shaft and, the helical threads of such sleeve engage each other.

6. The barbeque grill of claim 5, wherein the turning means' operative connections to the screw actuators are adapted for translating rotation about a horizontal axis into rotation about a vertical axis.

7. The barbeque grill of claim 6, wherein the turning means' operative connections comprise a plurality of paired bevel gears.

8. The barbeque grill of claim 6, wherein the turning means' operative connections comprise a worm gears, each worm gear operatively engaging with a toothed gear.

9. The barbeque grill of claim 1, wherein each quill and stem assembly comprises a cylindrical shaft telescopingly mounted within a cylindrical sleeve.

10. The barbeque grill of claim 9, wherein the plurality of quill and stem assemblies comprises at least a pair of quill and stem assemblies.

11. The barbeque grill of claim 10, wherein the at least pair of quill and stem assemblies is positioned either at a left end of the cabinet or at a right end of the cabinet.

12. The barbeque grill of claim 1, wherein each foot comprises a wheel.

13. The barbeque grill of claim 12, further comprising a plurality of releasable wheel locks, each releasable wheel lock being operatively connected to one of the wheels.
